(19) United States
(12) Patent Application Publication
(10) Pub. No.: US 2016/0216131 A1
(43) Pub. Date: Jul. 28, 2016

(54) LANDMARK-BASED NAVIGATIONAL SYSTEM

(71) Applicant: Panasonic Automotive Systems Company of America, Division of Panasonic Corporation of North America, Peachtree City, GA (US)

(72) Inventor: TEJAS KHORANA, MARIETTA, GA (US)

(73) Assignee: Panasonic Automotive Systems Company of America, Division of Panasonic Corporation of North America

(21) Appl. No.: 15/004,157

(22) Filed: Jan. 22, 2016

Related U.S. Application Data
(60) Provisional application No. 62/106,534, filed on Jan. 22, 2015.

(51) Int. Cl. G01C 21/36

(52) U.S. Cl. CPC G01C 21/3629; G01C 21/3644; G01C 21/3667

(57) ABSTRACT

A method of providing navigation directions to a driver of a motor vehicle includes identifying a landmark along a planned route of the vehicle. The landmark is not a single street, a stop sign or a traffic light. The driver is told where to turn with reference to the landmark.

### CROSS-REFERENCE TO RELATED APPLICATIONS

This application claims the benefit of U.S. Provisional Application No. 62/106,534, filed on Jan. 22, 2015, which the disclosure of which is hereby incorporated by reference in its entirety for all purposes.

### BACKGROUND OF THE INVENTION

1. Field of the Invention

The present invention relates to a method of operating a navigation system, and, more particularly, a method of operating a navigation system in a motor vehicle.

2. Description of the Related Art

One problem addressed by the present invention is that the directions that global positioning system (GPS) navigational devices give the driver are highly impersonal and hard to remember. The conventional GPS device helps a user strictly navigate from point A to point B, but it is not easy for the user to understand. Moreover, because road names are more difficult to remember than visually distinctive landmarks, visual scenes, and colloquial speech, the driver does not easily remember the route after he has driven it with the assistance of the navigation system. In addition, the repetitive phraseology of the navigation system is ineffective in holding a listener's attention, and consequently he may not comprehend or remember what heard, or at least was trying to listen to. Thus, the driver often needs to use the navigational system again the next time he drives that route.

### SUMMARY OF THE INVENTION

The invention may provide a GPS navigational system that addresses the above problems by giving the user personalized directions with a more personal touch than does a conventional GPS device. The inventive navigation system may provide the user with a set of directions that is much easier to remember than the directions provided by typical GPS devices. The directions may include landmarks that are generally well-known to the public or easily seen, such as restaurants, large buildings, statues, large pieces of art, businesses with large signs, billboards, etc.

In one embodiment, the directions provided by the GPS system may be personally customizable. For example, the user may be able to add and/or remove landmarks on the map on the display screen, such as by touching the screen at the location where the landmark is to be added or removed.

In another embodiment, the audible directions provided by the GPS navigation system are spoken in more colloquial terms than conventional GPS navigational language. For instance, instead of saying “take a right in 800 feet to Piedmont Road”, the inventive GPS system may say “take the third right past the intersection of Ponce de Lion Avenue and Richards Road onto Piedmont Road,” or “after passing the intersection of Ponce de Lion Avenue and Richards Road, lake the third right onto Piedmont Road,” or “take a second right after crossing the KFC onto Piedmont Road,” or “after passing the KFC on the left, take the second right onto Piedmont Road.” Thus, instead of merely telling the user the name of the road to turn on and the distance thereto, the inventive system may refer to things or places of reference that are easy for the user to see, such as restaurants or intersections of roads, for example.

When providing the initial directions, landmarks, or at least landmarks that are not conventionally provided, may be omitted from the map on the display screen in order to facilitate the user getting a feel for the area he is going to, such as by enabling him to focus on the layout of the streets and the names of the streets to the extent that he can. The map on the display screen may initially include indications of some well-known or famous landmarks that are disposed along the way to the destination. Such landmarks may be easily removed from the screen map before the user starts the car. Also, the user may easily add desired landmarks to the screen map before the user starts the car.

While driving, the user may add landmarks to the on-screen map by touching the screen and audibly saying what landmark is located there, e.g., by naming the added landmark. These personally created landmarks may he added to the inventive personal GPS navigational system such that these new landmarks will he available for use and included in future directions.

In addition to the visual aid provided by landmarks according to the invention, the audio provided by the navigation system can be enhanced so that the directions are given in more colloquial terms which are easier for the user to understand and remember. Landmarks may be referred to in the audio directions. Colloquial or slang expressions or phrases, such as “turn the corner” or “hang a right” may be included, and the variety provided by these colloquial or slang expressions may hold the listener's attention and help him to remember what was said. As another example, instead of saying “turn right at the third cross street”, the system may say “take the third right.” In addition to telling the user where to turn, the system may add at the beginning of the instruction a colloquial expression such as “go straight past the tall skinny red building”, etc.

The present invention may enable users to better remember the directions from one place to another and may enable users to develop better navigational skills by having the directions be put in terms of pictures and images (e.g., of landmarks) and colloquial direction terms. The monotonous directions given by a conventional navigation system do not provide the benefits of a more personal set of directions with colloquial speech and personalized landmarks. The colloquial speech and personalized landmarks may help driver remember the directions and better understand the city around him.

The invention comprises, in one form thereof, a method of providing navigation directions to a driver of a motor vehicle, including identifying a landmark along a planned route of the vehicle. The landmark is not a single street, a stop sign or a traffic light. The driver is told where to turn with reference to the landmark.

The invention comprises, in another form thereof, a method of providing navigation directions to a driver of a motor vehicle, including identifying a planned route of the vehicle. Colloquial text directions are created based on the planned route. The colloquial text directions including other than distances to a next turn, a direction of the turn, and a name of a street to turn on. The colloquial text directions are audibly presented to the driver.

The invention comprises, in yet another form thereof, a method of providing navigation directions to a driver of a motor vehicle, including enabling the user to add an icon representing a landmark to a map on a display screen. The map is provided by a navigation system. The driver is told where to turn with reference to the landmark.

An advantage of the present invention is that it enables the user to navigate with the benefit of colloquial terms, landmarks, and custom landmarks for improved memorization of directions by the user.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is an example screen shot of a map that may be used in conjunction with one embodiment of the invention.

FIG. 2 is another example screen shot of a map that may he used in conjunction with an embodiment of the invention.

FIG. 3 is an example screen shot of a map illustrating a first step of one embodiment of a method of the invention for adding a personal landmark to navigation information, possibly while driving.

FIG. 4 is an example screen shot of a map illustrating a second step of one embodiment of a method of the invention for adding a personal landmark, possibly while driving.

FIG. 5 is a block diagram of one embodiment of a landmark-based navigational arrangement of the present invention.

FIG. 6 is a flow chart of another embodiment of a method of the invention for using a personal landmark in providing navigation information.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

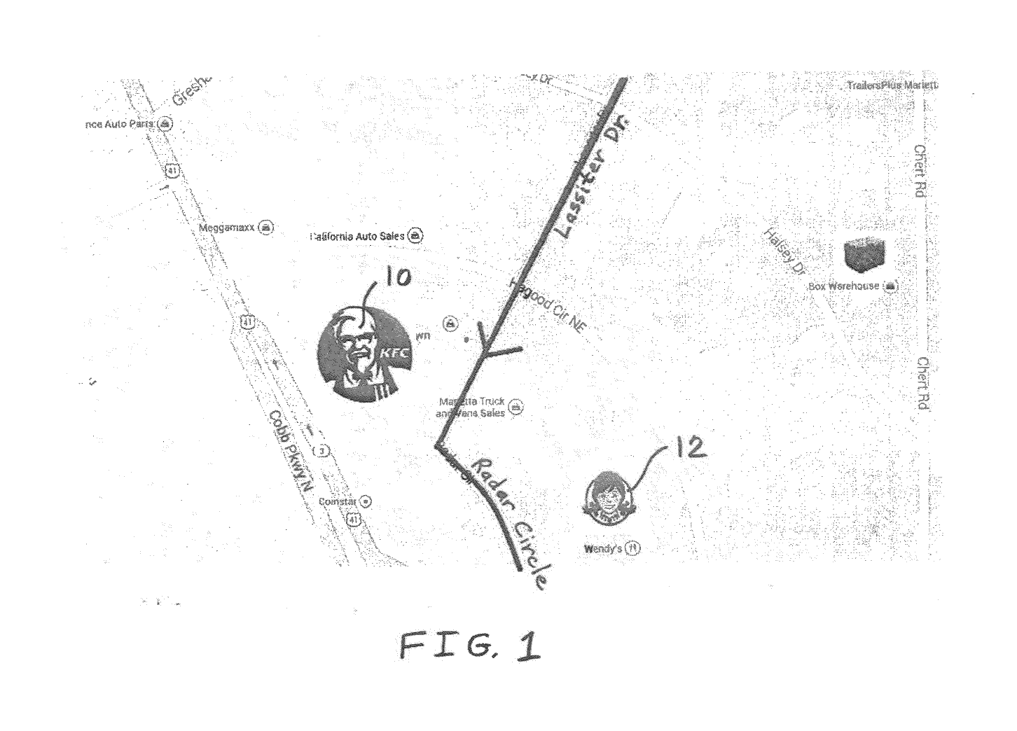

FIG. 1 is a screen shot of an example on-screen map that may be used in conjunction with one embodiment of the present invention. Icons representing landmarks such as the KFC restaurant icon 10 and the Wendy's restaurant icon 12 may have been automatically provided by the inventive navigation system, or may have been manually added to the map by the user. The following example colloquial directions, referring to the landmarks represented by icons 10, 12, may be audibly spoken and/or displayed as text on the display screen: “Pass the KFC on your right on. Lassiter Drive and take the next left onto Radar Circle”, and “Continue on Radar Circle past Wendy's on your left until you reach your destination.”

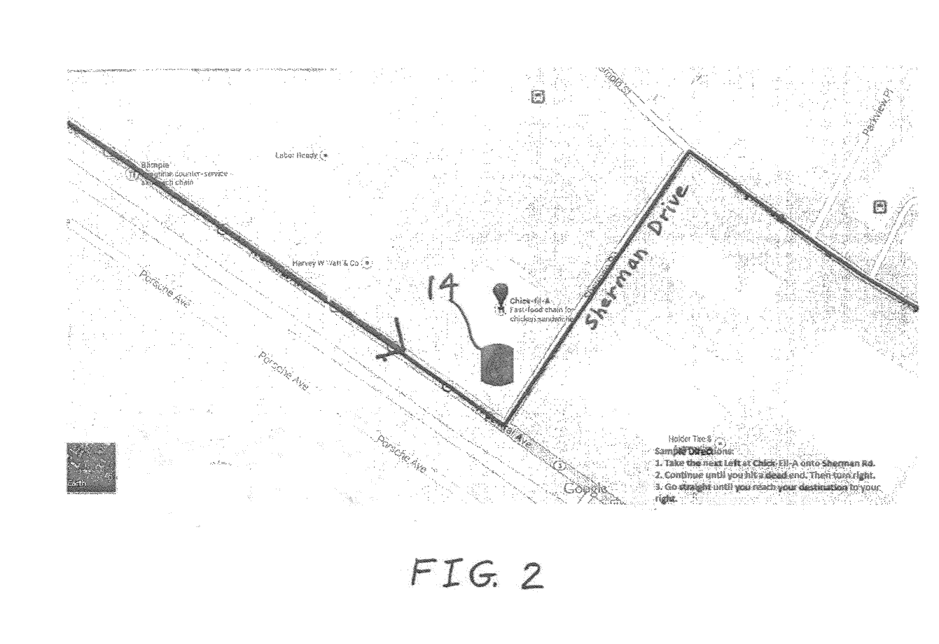

FIG. 2 is another screen shot of an example on-screen map that may be used in conjunction with one embodiment of the present invention. Icons representing landmarks such as the Chick-Fil-A restaurant icon 14 may have been automatically provided by the inventive navigation system, or may have been manually added to the map by the user. The following example colloquial directions, referring to the landmark represented by icon 14, may be audibly spoken and/or displayed as text on the display screen: “Take the next left at Chick-Fil-A onto Sherman Drive”, “Continue until you reach a dead end, and then turn right”, and “Go straight until you reach your destination on your right.”

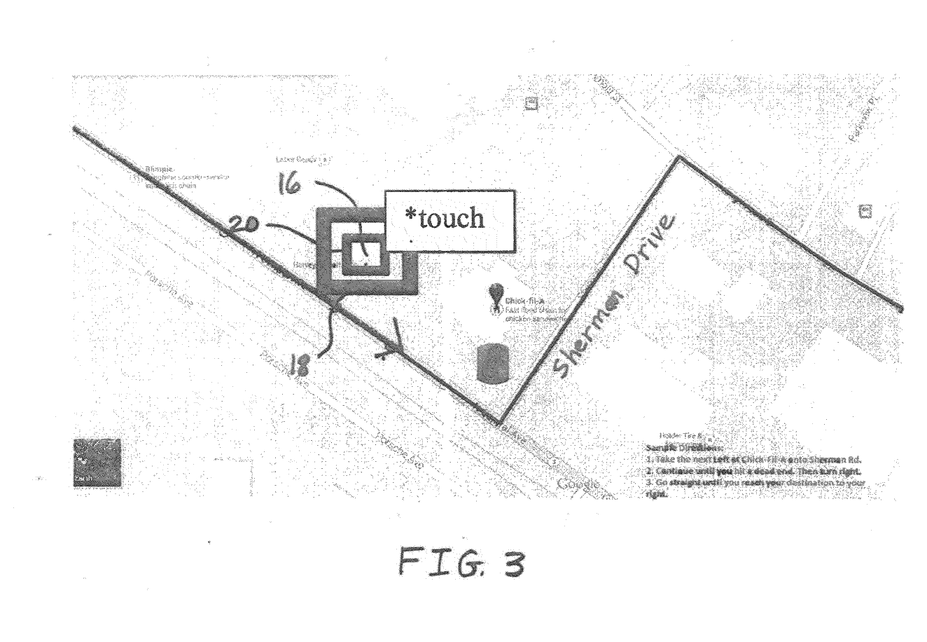

FIG. 3 is yet another screen shot of the example on-screen map of FIG. 2 that may be used in conjunction with one embodiment of a method of the present invention for enabling a user to create landmarks on the map, possibly while driving. The user may touch the touch-sensitive screen with his finger at location 16. In response to sensing the touch at location 16, the system may display concentric rectangles 18, 20 that are centered on location 16 in order to provide visual feedback to the user regarding where on the screen the icon will be placed (e.g., to pinpoint location 16). The system may then audibly and/or visually prompt the user to tell the system what name the icon at location 16 should be called. For example, the following text may be displayed on the screen: “What would you like to name the icon at this location?” Alternatively, or in addition, the system may audibly state this question such that the user can hear the question. In response, the user may speak the name that he wants the landmark to be called. A microphone of the system may pick up the name spoken by the user.

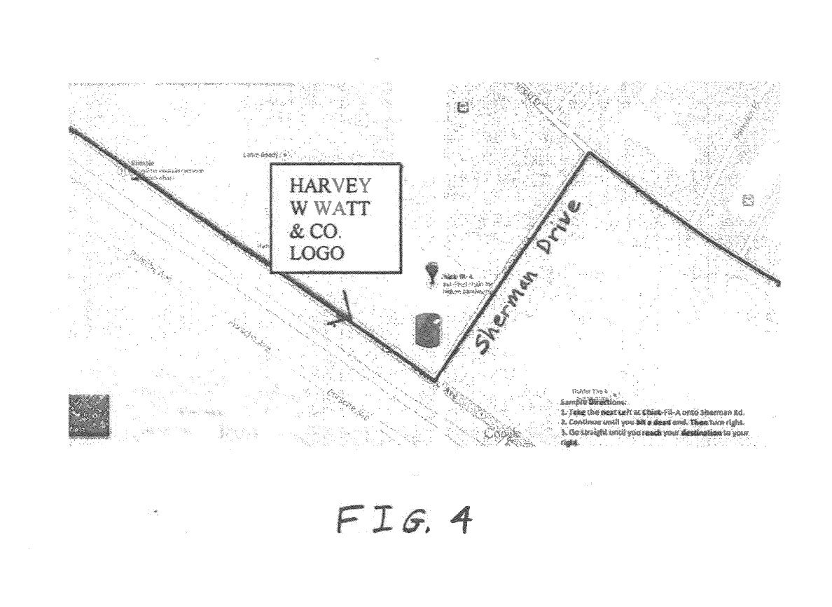

In the example illustrated in FIG. 4, the user has spoken the name “Harvey W. Watt and Company”. In response to the microphone detecting these spoken words, the system prints the following text on the screen, as shown in FIG. 4: “HARVEY W WATT & CO LOGO”. The global positioning system (GPS) of the vehicle may confirm that a landmark of this name, or of a similar name, does indeed exist within a threshold distance of location 16 (e.g., is within outer rectangle 18). If the GPS cannot confirm that a landmark of a similar name is within the threshold distance, then the system may inform the user of this audibly and/or visually. If the GPS determines that that a landmark of a similar name exists, but is outside the threshold distance, then the system may audibly and/or textually inform the user of the similar name and may show the user on the screen where the landmark actually is. The user may then be enabled to accept the landmark so found by the system and have it displayed on the map. If the GPS determines that that a landmark of a different name exists at location 16, then the system may audibly and/or textually inform the user of the different name and may show the user that the differently named landmark is at location 16. The user may then be enabled to accept the landmark so found by the system and have it displayed on the map.

Conversely, if the GPS of the vehicle does confirm that a landmark of the name spoken by the user, or of a similar name, does indeed exist within a threshold distance of location 16, then the system may wirelessly search the Internet for a logo matching the name if the logo is not already made available by the GPS system. The system may display a number of candidate logos corresponding to the name, and the user may be enabled to select one of the candidate logos for display at location 16. However, if the GPS does provide the logo, or if the interact search finds only one candidate logo, then the logo may be automatically displayed at location 16. The landmark and its logo may be stored in system memory for future use.

Audio directions may incorporate or refer to the new landmark added by the user. For example, the directions before the landmark is added may state “go straight and take a right at Chick-Fil-A onto Sherman Road”, but after the landmark is added by the user the directions may state “go past Harvey W Watt and Company and take a right at Chick-Fil-A onto Sherman Road.”

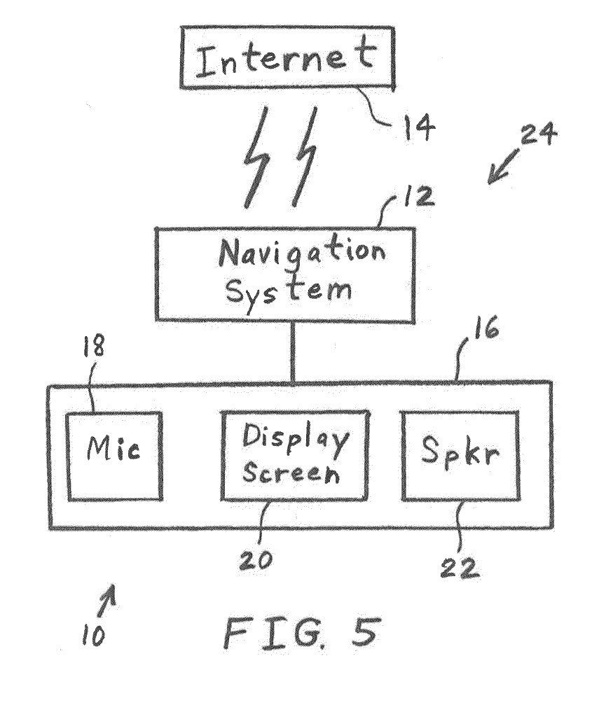

FIG. 5 illustrates one embodiment of a landmark-based navigational arrangement 10 of the present invention, including a navigation system 12 wirelessly connected to the Internet 14. Navigation system 12 may be connected to a user interface 16 including a microphone 18, a touch-sensitive display screen 20, and a loudspeaker 22. Arrangement 10 may be operated according to any of the methods described above. Navigation system 12 and user interface 16 may be included in a same motor vehicle 24.

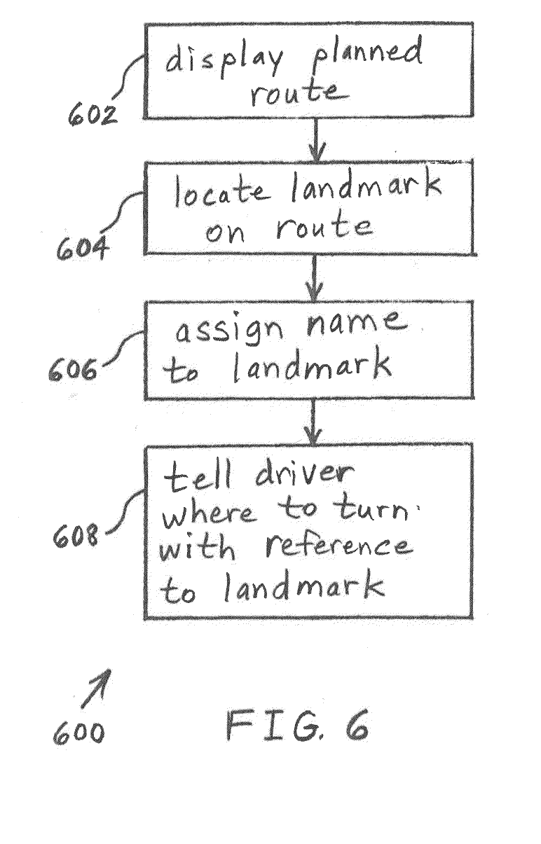

FIG. 6 illustrates a flow chart of another embodiment of a method 600 of the invention for using a personal landmark in providing navigation information. In a first step 602, a planned route of a vehicle is displayed. For example, a driver of vehicle 24 may enter a destination address via microphone 18 or touch-sensitive display screen 20. Navigation system 12 may then calculate a route to the address, possibly by use of Internet 14, and display the route on display screen 20.

In a next step 604, a landmark on the route is located. For example, the driver may touch display screen 20 at a location on the displayed map corresponding to the location of the landmark. Alternatively, the driver may enter an address or intersection of the landmark into the system via microphone 18 or touch-sensitive display screen 20.

Next, in step 606, a name is assigned to the landmark. For example, the driver may enter a name, such as “McDonald's” into the system via microphone 17 or touch-sensitive display screen 20. Alternatively, navigation system 12 may use Internet 14 to find the name of a landmark associated with an address provided by the driver.

In a final step 608, the driver is provided driving instructions with reference to the name of the landmark. For example, the driver may be told audibly or textually to “take the first right after you pass the McDonald's on your left”. Of course, a turn does not necessarily have to be included in the instructions. For example, the driver may be told audibly or textually to “continue northbound on Main Street for one mile after you pass the McDonald's on your left.”

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of providing navigation directions to a driver of a motor vehicle, the method comprising the steps of:
identifying a landmark along a planned route of the vehicle, the landmark not being a single street, a stop sign or a traffic light; and
telling the driver where to turn with reference to the landmark.

2. The method of claim 1 wherein the driver is told where to turn by use of colloquial language.

3. The method of claim 1 wherein the landmark is a restaurant.

4. The method of claim 1 comprising the father step of enabling the user to add an icon representing the landmark to a map on a display screen, the map being provided by a navigation system that provides the directions.

5. The method of claim 4 comprising the further steps of:
enabling the user to name the landmark; and
using the name provided by the user when referring to the landmark.

6. The method of claim 5 comprising the further step of enabling the user to indicate a location on the map where the icon is to be added.

7. The method of claim 6 comprising the further step of displaying concentric rectangles on the map on the display screen, the rectangles being centered on the location indicated by the user.

8. A method of providing navigation directions to a driver of a motor vehicle, the method comprising the steps of:
identifying a planned route of the vehicle;
creating colloquial text directions based on the planned route, the colloquial text directions including other than distances to a next turn, a direction of the turn, and a name of a street to turn on; and
audibly presenting the colloquial text directions to the driver.

9. The method of claim 8 wherein the colloquial text directions refer to a landmark along the planned route of the vehicle, the landmark not being a single street, a stop sign or a traffic light.

10. The method of claim 9 comprising the further step, before the creating step, of enabling the user to add an icon representing the landmark to a map on a display screen, the map being provided by a navigation system of the vehicle.

11. The method of claim 10 comprising the further steps of:
enabling the user to name the landmark; and
using the name provided by the user when referring to the landmark in the colloquial text directions.

12. The method of claim 11 comprising the further step of enabling the user to indicate a location on the map where the icon is to be added.

13. The method of claim 12 comprising the further step of displaying concentric rectangles on the map on the display screen, the rectangles being centered on the location indicated by the user.

14. The method of claim 8 wherein the method of claim 9 wherein the landmark is a restaurant.

15. A method of providing navigation directions to a driver of a motor vehicle, the method comprising the steps of:
enabling the user to add an icon representing a landmark to a map on a display screen, the map being provided by a navigation system; and
telling the driver where to turn with reference to the landmark.

16. The method of claim 15 wherein the driver is told where to turn by use of colloquial language.

17. The method of claim 15 wherein the landmark is a restaurant.

18. The method of claim 15 comprising the further steps of:
enabling the user to name the landmark; and
using the name provided by the user when referring to the landmark.

19. The method of claim 18 comprising the further step of enabling the user to indicate a location on the map where the icon is to be added.

20. The method of claim 19 comprising the further step of displaying concentric rectangles on the map on the display screen, the rectangles being centered on the location indicated by the user.
